(19) United States
(12) Patent Application Publication
(10) Pub. No.: US 2003/0210708 A1
(43) Pub. Date: Nov. 13, 2003

(54) Digital telephone system and protocol for joint voice and data exchange via pots line

(76) Inventor: Maxim B. Belotserkovsky, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/140,562

(22) Filed: May 7, 2002

(51) Int. Cl. H04J 1/02; H04J 3/22

(52) U.S. Cl. 370/468; 370/493

(57) ABSTRACT

A telephone system connects to a plain old telephone service (POTS) line and includes a modem connected to the POTS line. A telephone transceiver and a data device are coupled to the modem to provide a simultaneous two-way data and voice exchange over the POTS line by detecting data for transfer and allocating bandwidth between voice and data signals to accommodate the exchange.

### FIELD OF THE INVENTION

The present invention generally relates to network communications and, more particularly, to a telephone system that permits concurrent transmit/receive digitized voice and generic data to/from a compatible digital telephone system. In addition, the system may be operated as a conventional telephone system when the system is not equipped with a compatible digital telephone system.

### BACKGROUND OF THE INVENTION

Plain old telephone service (POTS) lines are typically used by subscribers to either carry data to communicate between devices equipped with compatible digital modems or to carry analog telephone conversations between parties equipped with analog telephone systems. Often it is desirable, however, to be able to exchange data simultaneously while having a telephone conversation.

To permit this, conventional systems use Internet as the primary data exchange medium, which, among other things, permit the users to establish virtual voice connections. However, in this scheme the user can only place outgoing calls and the quality of service is not guaranteed.

Conventional devices capable of transmitting data via POTS lines include personal computers and specialized appliances that are used to connect to the Internet and/or establish point-to-point connections between pairs of such devices. However, such digital devices, when in use, occupy the telephone line exclusively thus preclude simultaneous conversation with the party.

Therefore, a need exists for a telephone system, which combines the utility and convenience of a regular telephone with the added benefits of a data-capable device. A further need exists for a telephone system, which provides for simultaneous usage of a telephone line for both voice and data services.

### SUMMARY OF THE INVENTION

A telephone system connects to a plain old telephone service (POTS) line and includes a modem connected to the POTS line. A telephone transceiver and a data device are coupled to the modem to provide a simultaneous two-way data and voice exchange over the POTS line by detecting data for transfer and allocating bandwidth between voice and data signals to accommodate the exchange.

A method for simultaneously exchanging voice and data over an analog telephone line includes providing a plain old telephone service (POTS) line, a modem connected to the POTS line, a telephone transceiver and a data device coupled to the modem. Data transfer activity is determined by the modem listening on the POTS line and data exchange is established. A voice connection is established over the POTS line to provide a simultaneous two-way data and voice exchange over the POTS line by employing voice codecs to exchange voice signals. Bandwidth is allocated between the voice and data signals over the POTS line.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is an exemplary telephone system for joint voice and data exchange via POTS line in accordance with the present invention; and

FIG. 2 is a block/flow diagram of an illustrative method for simultaneously exchanging voice and data signals over an analog telephone line in accordance with an embodiment of the present invention.

It should be understood that the drawings are for purposes of illustrating the concepts of the invention and are not necessarily the only possible configuration for illustrating the invention.

### DETAILED DESCRIPTION OF THE INVENTION

The present invention provides a telephone system, which permits a single telephone line to transmit and receive voice and data simultaneously. The present invention provides a solution (fully compatible with existing telephone service) that permits seamless establishment of mixed voice/data point-to-point connections (both incoming and outgoing) with compatible digital systems, as well as the establishment of voice-only connections with conventional analog telephone systems.

The user interface of the present invention includes features emulating a conventional telephone system, and the selection of the mode of operation (digital or analog) is transparent to both end users through the emulation of the conventional analog telephone signaling. This makes the system of the present invention an acceptable replacement for existing analog telephone systems. At the same time, when both parties are equipped with compatible versions of the system of the present invention, the parties can engage in a conversation, while simultaneously exchanging data, such as text, graphics, etc.

It is to be understood that the present invention is described in terms of a telephone system; however, the present invention is much broader and may include any digital multimedia devices, which are capable of connection to and the delivery of voice and data over a switched network. For example, the present invention is applicable to any telephone communication system, which includes end-user devices such as, wireless or wired telephones, modems, personal digital assistants (PDAs), etc. The concepts of the present invention may be extended to wireless or other network types using analog or digital technology.

It should be understood that the elements shown in the FIGS. may be implemented in various forms of hardware, software or combinations thereof. Preferably, these elements are preferably implemented in a combination of hardware and software on one or more appropriately programmed general purpose devices, which may include a processor, memory and input/output interfaces.

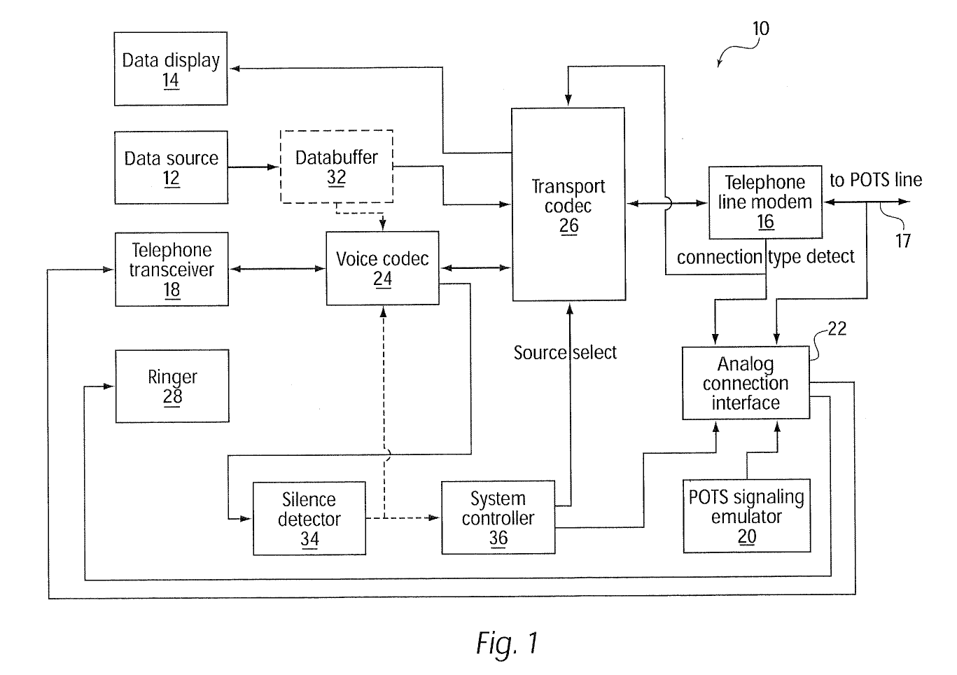

Referring now in specific detail to the drawings in which like reference numerals identify similar or identical elements throughout the several views, and initially to FIG. 1, a system 10 is shown in accordance with the present invention. System 10 is preferably fully compatible with existing telephone service and permits seamless establishment of mixed voice/data point-to-point connections (both incoming and outgoing) with the users of compatible digital systems. In addition, system 10 includes the capability of establishing voice-only connections with conventional analog telephone systems.

System 10 is a user interface, which includes features emulating a conventional telephone system. The selection of a mode of operation (digital or analog) is transparent to both end users through the emulation of the conventional analog telephone signaling, making it an acceptable replacement for existing analog telephone systems. At the same time, when both parties are equipped with compatible versions of the present invention, they can engage in a conversation, while simultaneously exchanging data, such as text, graphics, etc.

System 10 includes all of the functionality and user interface of a conventional telephone system, which permits system 10 to be used for both initiating and receiving POTS calls. At the same time, system 10 permits for data source(s) 12 and data display(s) 14 to be connected to it and used along with the voice conversation when the system is connected to another system with compatible specifications. Four operation scenarios will now be described to further illustratively describe the present invention.

In one scenario, a call is to be placed to a POTS system. A telephone number is dialed and circuitry of a modem 16 listens for a modem on the other end to pick up over a POTS line 17. Meanwhile, a transceiver 18 is supplied through analog connection interface 22 with an emulation of the POTS waiting-to-pickup signal via emulator 20. The POTS telephone (not shown) is picked up on the other end. While the connection type is being detected at interface 22, a transceiver 18 continues being supplied with an emulation of the POTS waiting-to-pickup signal. If no data connection is detected by modem 16, control is passed to analog connection interface 22. Transceiver 18 preferably includes a telephone speaker and microphone for human voice interaction.

Next, emulation of the POTS waiting-to-pickup signal to transceiver 18 is discontinued. An analog voice connection is patched through between transceiver 18 and the party on the other end. This connection is patched through a voice coder/decoder (codec) 24 and a transport layer codec 26.

Receiving a call from the POTS system, the call is received and modem 16 listens for a modem on the other end to attempt to establish a data connection. If no data connection is detected by modem 16, control is passed to analog connection interface 22. A ringer 28 is supplied with an emulation of a ringing signal from emulator 20. Meanwhile, an audio feedback signal is sent via POTS line 17 to the calling party informing the calling party that the phone is ringing (the feedback can be a voice prompt, an emulation of POTS waiting-to-pickup signal, etc.). If the phone is picked up, emulation of ringing signal to ringer 28 and the audio feedback signal to the calling party is discontinued. An analog voice connection is then patched through between transceiver 18 and the party on the other end.

Placing a call to a compatible digital telephone system enables additional capabilities. In this scenario, a number is dialed, and modem 16 listens for a modem on the other end to pick up. Meanwhile, transceiver 18 is supplied with an emulation of the POTS waiting-to-pickup signal from emulator 20. A compatible digital telephone (not shown) pick up is awaited on the other end. While the connection type is being detected and the data connection is being established, transceiver 18 continues to be supplied with an emulation of the POTS waiting-to-pickup signal.

Modem 16 detects another modem on the other end and establishes a point-to-point data connection, such as a point to point protocol (PPP) protocol-compatible connection. At this point, a higher level protocol check (e.g., transport layer, etc.) may be needed to ensure that the party on the other end complies with all the needed protocols, and not just that of the point-to-point connection.

If a compatible data connection checks-out all right, a transport connection per system protocol is established through transport codec 26 and system 10 waits for the party on the other end to pick up. If the party picks up, emulation of the POTS waiting-to-pickup signal to transceiver 18 is discontinued from emulator 20. Digitized voice is patched through between voice codecs 24 on the two ends of the connection to establish a POTS telephone conversation emulation in accordance with the present invention. Data exchange between the two parties can now take place.

The present invention contemplates several implementations of data exchange. Three illustrative embodiments of voice/data co-transmission will now be described in accordance with the present invention.

In a first embodiment, the voice connection is the master connection. Data to be sent from data source 12 is buffered in a data buffer 32 and sent to transport codec 26 only when a silence detector 34 detects pauses (silence) in the audio signal (both natural and intentional). Note that manual voice/data switching is also possible and may be implemented in system 10 as a dedicated switch or a push of a keypad button, etc. In this scenario, all of the data bandwidth may be allocated to either data source 12 (on either end of the connection) at any given time.

In a second embodiment, voice and data connections coexist in time. The total bandwidth is divided between the digitized voice and data and this partition remains fixed in time. In a third embodiment, voice and data connections again coexist in time. However, a variable bitrate voice codec 24 is utilized. A bandwidth partition between the digitized voice and data can be controlled by for example, output from silence detector 34, a control signal from a system controller 36, a fill level of data buffer 32, etc.

In receiving a call from a compatible digital telephone system, the call is received and modem 16 listens for a modem on the other end to attempt to establish a compatible data connection. If modem 16 detects another modem on the other end, modem 16 establishes a point-to-point data connection—such as a PPP protocol-compatible. At this point, a higher level protocol check (transport layer, etc.) may be needed to ensure the party on the other end complies with all the needed protocols, and not just that of the point-to-point connection. If a compatible data connection checks-out all right, a transport connection per system protocol is established through transport codec 26. Ringer 28 is then supplied with an emulation of the ringing signal from emulator 20. If the phone is picked up, digitized voice is patched through between voice codecs 24 on the two ends of the connection to establish a POTS telephone conversation emulation in accordance with the present invention.

System controller 36 provides control signals, which regulate switching and data flow through system 10 during active connection times. Modem 16 is coupled to analog connection interface 22 to assist in classifying connection types during connection procedures. Controller 36 provides a source select signal to transport codec 26 based on input for silence detector 34. For example, sources may be changed for a given transmission after a period of silence or pause in transmission. Change in sources may refer to data/voice or data sources between different end users. Controller 36 may include one or more semiconductor chips with software programs for implementing system functions.

Data display 14 may include a liquid crystal or other display, such as a computer monitor, which displays or otherwise utilizes data transported over POTS line 17 in accordance with the present invention. Display 14 may include an interactive display, such as a touch screen display or a graphical user interface. Data source 12 may be integrated into a telephone of system 10 or may include a connection to an external data source, such as a computer or other data storage device. System 10 may include multiple data sources 12. These multiple data sources may be employed one source at a time or multiplexed to simultaneously send data from all sources.

The present invention is preferably employed for digital telephone systems. Elements of system 10 may be distributed between a telephone, customer premises equipment (CPE) and/or a central office. However, in a preferred embodiment system 10 is incorporated into a digital telephone, which employs a POTS line connection. System 10 may include other features common to telephone systems, such as for example, answering services, call waiting, call forwarding and any other service.

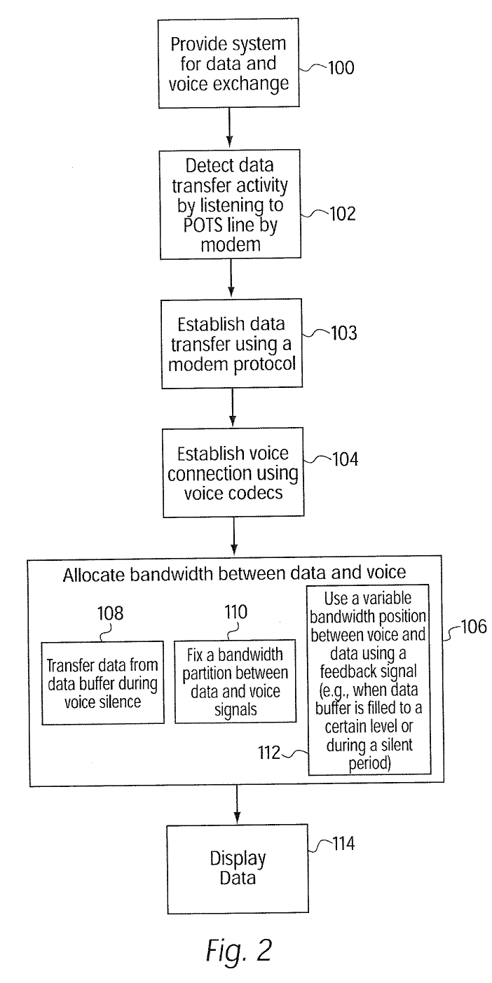

Referring now to FIG. 2, a block/flow diagram shows an illustrative method for simultaneously exchanging voice and data over an analog telephone line in accordance with the present invention. In block 100, system 10 is provided which includes a modem, which can be connected to a POTS line, a telephone transceiver and a data device coupled to the modem. In block 102, the modem is employed to listen to the POTS line to detect if data transfer activity is present. Data transfer activity may be initiated by the modem to another modem. For example, in the event that data is to be transferred to a remote modem, the modem prompts and listens for a response from the remote modem. The modem interaction may employ a standard modem protocol. Data transfer activity may be initiated by a remote modem. In this case, the modem listens for a remote modem attempting to establish communications. Data transfer activity may be established in block 103, preferably using a modem protocol such as PPP.

In block 104, a voice connection can now be established over the POTS line. Advantageously, the present invention may be employed in establishing voice communication only without data transfer. However, the present invention can also provide a simultaneous two-way data and voice exchange over the POTS line by employing voice codecs to exchange voice signals. In block 106, bandwidth is allocated between the voice and data signals over the POTS line. Bandwidth may allocated in a plurality of ways. In block 108, the data device includes at least one data source, which is coupled to the modem. The data from the data source may be stored in a data buffer and is transmitted from the data buffer during pauses in the voice exchange. These pauses are detected by, for example, the silence detector described with reference to FIG. 1. Alternately, data from the data buffer may be sent when the buffer is filled to a predetermined level.

In block 110, allocating bandwidth between voice and data signals may include fixing a bandwidth partition between voice and data signals and maintaining the partition during a connection. In block 112, allocating bandwidth between voice and data signals may include employing a variable bandwidth partition between voice and data signals. This may be achieved by generating a feedback signal to enable data flow when a data buffer is filled to a certain level or by a silence detector when a pause in voice transmission is detected. Data receiver may be displayed, in block 114, on a display device (14) of the telephone device.

Having described preferred embodiments for a digital telephone system and protocol for joint voice and data exchange via POTS line (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A telephone system which connects to a plain old telephone service (POTS) line, comprising:
a modem for connecting to a POTS line;
a telephone transceiver and a data device coupled to the modem to provide a simultaneous two-way data and voice exchange over the POTS line by detecting data for transfer and allocating bandwidth between voice and data signals to accommodate the exchange.

2. The telephone system as recited in claim 1, wherein the data device includes at least one data source coupled to the modem.

3. The telephone system as recited in claim 1, wherein the data device includes at least one data display coupled to the modem for receiving and displaying data over the POTS line.

4. The telephone system as recited in claim 1, further comprising a transport coder/decoder (codec) which processes data and voice signals to and from the POTS line through the modem.

5. The telephone system as recited in claim 4, wherein the transport codec includes a protocol, which establishes data transfer during a telephone conversation.

6. The telephone system as recited in claim 1, further comprising a voice coder/decoder (codec) coupled to the transceiver and the modem, the voice codec supporting voice transmission and reception during data exchange operations.

7. The telephone system as recited in claim 1, further comprising a data buffer coupled to the data device to provide bandwidth control for data transmission/reception exchanges.

8. The telephone system as recited in claim 1, further comprising a system controller, which allocates bandwidth in accordance with a feedback signal.

9. The telephone system as recited in claim 8, wherein the feedback signal is generated when a data buffer is filled to a level.

10. The telephone system as recited in claim 8, wherein the feedback signal is generated by a silence detector when a pause in transmission is detected.

11. The telephone system as recited in claim 1, wherein the modem, the telephone transceiver and the data device are incorporated into a single telephone device.

12. A method for simultaneously exchanging voice and data over an analog telephone line, comprising the steps of:
providing a plain old telephone service (POTS) line, a modem connected to the POTS line, a telephone transceiver and a data device coupled to the modem;
detecting data transfer activity by the modem listening on the POTS line to establish a data exchange connection;
establishing a voice connection over the POTS line to provide a simultaneous two-way data and voice exchange over the POTS line by employing voice codecs to exchange voice signals; and
allocating bandwidth between the voice and data signals over the POTS line.

13. The method as recited in claim 12, wherein the data device includes at least one data source coupled to the modem, and the method further comprises the steps of storing data in a data buffer and transmitting data from the data buffer during pauses in the voice exchange.

14. The method as recited in claim 12, further comprising the step of displaying data received over the POTS line by the modem.

15. The method as recited in claim 12, wherein the step of allocating bandwidth includes fixing a bandwidth partition between voice and data signals and maintaining the partition during a connection.

16. The method as recited in claim 12, wherein the step of allocating bandwidth includes employing a variable bandwidth partition between voice and data signals.

17. The method as recited in claim 16, wherein the step of allocating bandwidth includes generating a feedback signal to enable data flow when a data buffer is filled to a level.

18. The method as recited in claim 16, wherein the feedback signal is generated by a silence detector when a pause in transmission is detected.

19. The method as recited in claim 16, wherein the step of detecting data transfer by the modem listening on the POTS line includes employing a modem protocol to establish data transfer between modems.
